(19) United States
(12) Patent Application Publication
(10) Pub. No.: US 2009/0205717 A1
(43) Pub. Date: Aug. 20, 2009

(54) FAUCET STRUCTURE HAVING PRESSURE BALANCE VALVES

(75) Inventor: Chin-Hua YUAN, Taichung County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: GLOBE UNION INDUSTRIAL CORP., Taichung Export Processing Zone (TW)

(21) Appl. No.: 12/031,912

(22) Filed: Feb. 15, 2008

(51) Int. Cl. G05D 11/02

(52) U.S. Cl. 137/100

(57) ABSTRACT

A faucet structure having pressure balance valves includes a valve seat, a control valve set, and pressure balance valve sets. The valve seat has a valve chamber for the control valve set to be disposed therein, and has a water entry and a water exit. The pressure balance valve sets are disposed in the entry, and capable of closing the entry. A valve sheet of the pressure balance valve sets has a protrusion extending into the valve chamber, and the control valve set has a guide portion at an end extending into the valve chamber corresponding to the protrusion, such that when the control valve set is disposed in the valve chamber, the guide portion pushes against the protrusion, so as to enable the pressure balance valve sets to open the entry. When the control valve set is detached, the pressure balance valve sets are capable of closing the entry.

### BACKGROUND OF THE INVENTION

1. Field of the Invention

The present invention generally relates to a faucet, in particular, to a faucet structure having pressure balance valve sets therein and capable of automatically closing a water entry when detaching a control valve set.

2. Description of Related Art

Referring to FIG. 6, it shows a conventional faucet, which mainly includes a valve seat 8 and a body 9.

The valve seat 8 has a valve chamber 81, and has two water entries 82, 83 and one water exit 84 disposed within the valve chamber 81. The two water entries 82, 83 extend to penetrate the valve seat 8, so as to respectively form inlet pipes 82a, 83a. The water exit 84 extends to penetrate the valve seat 8, so as to form two outlet pipes 84a, 84b that are communicated with each other.

A control valve set (not shown) is disposed within the body 9, and is manipulated through a handle 91. The control valve set has water inlets 92, 93 and a water outlet 94 respectively corresponding to the water entries 82, 83 and the water exit 84 of the valve seat 8.

When actually using the above faucet, the inlet pipes 82a, 83a and the outlet pipes 84a, 84b are respectively joined with relevant inlet pipelines and outlet pipelines, and then buried and disposed in a washstand or a wall. In other words, once the faucet has been installed, only the body 9 can be detached for maintenance or replacement.

However, the above faucet structure still needs to be improved.

Firstly, before detaching the body 9 for maintenance or replacement, the water supply must be closed through turning off a tap of the water supply; however, the tap is generally disposed outdoors or beside a water tower or water meter on the top floor of the building. Therefore, the maintainers must firstly leave for the place where the tap of the water supply is installed to close the water supply, and then return to the house to drain off the water in the pipeline by opening the faucet, and then detach the body 9 for maintenance or replacement, which is tedious and causes troubles for the maintainers.

Furthermore, when manufacturing the valve seat 8, the water entries 82, 83 and the water exit 84 must be manufactured within the valve seat 8 made of metal, and the water entries 82, 83 and the water exit 84 within the valve seat 8 all have bended or even twisted configurations, so that the complexity and difficulty of the manufacturing process are thus increased, which not only increases the product cost, but also raises the defect rate of the product.

### SUMMARY OF THE INVENTION

Accordingly, the present invention is directed to a faucet structure having pressure balance valve sets disposed in a valve seat, which is capable of automatically closing a water entry when detaching a control valve set.

The present invention is further directed to a faucet structure having a plurality of diversion channels integrally formed in a lower casing of the control valve set, which is capable of simplifying the manufacturing process, reducing the manufacturing cost, and increasing the yield.

According to an embodiment of the present invention, a faucet including a valve seat, a control valve set, and more than one pressure balance valve sets is provided. The valve seat has a valve chamber for the control valve set to be disposed therein, and has a water entry and a water exit communicating with an exterior from the valve chamber. The control valve set has pipes respectively corresponding to the water entry and the water exit of the valve seat. The pressure balance valve sets are disposed in the water entry and have a protrusion extending into the valve chamber, which are capable of automatically closing the water entry when without being acted by other components. The control valve set has a guide portion at an end extending into the valve chamber corresponding to the protrusion, such that the guide portion pushes against the protrusion to enable the pressure balance valve sets to open the water entry.

As the pressure balance valve sets are at the opened state after being pushed by the guide portion of the control valve set, once the control valve set is detached, the pressure balance valve sets can automatically close the water entry. Therefore, the control valve set can be conveniently maintained or replaced, without necessarily turning off the tap of the water supply before detaching the control valve set.

Furthermore, the lower casing of the control valve set is manufactured into an integrated structure through plastic injection moulding, and a plurality of diversion channels communicating the water entry and the water exit with the control valve set is integrally formed within the lower casing. Therefore, the manufacturing process is simplified, the cost is reduced, and the production yield is increased.

In order to make the aforementioned and other objects, features and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an outside view of the present invention;

FIG. 2 is an exploded perspective view of the present invention;

FIG. 3 is a cross-sectional view of a combination of pressure balance valve sets and a seat body according to the present invention;

FIG. 4 is a schematic view of a using state of the present invention;

FIG. 5 is a schematic view of another using state of the present invention; and

FIG. 6 is a schematic structural view of a conventional faucet.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

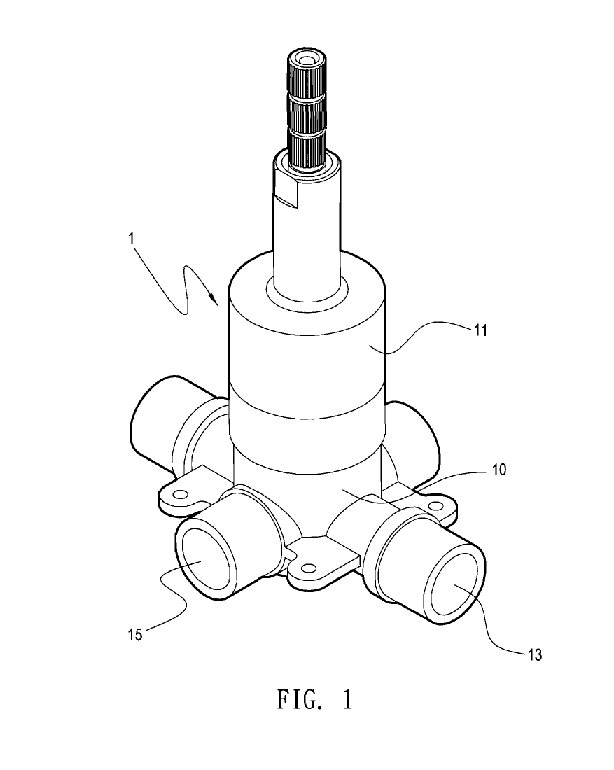

Referring to FIGS. 1 to 5, they show a structure of a preferred embodiment of the present invention.

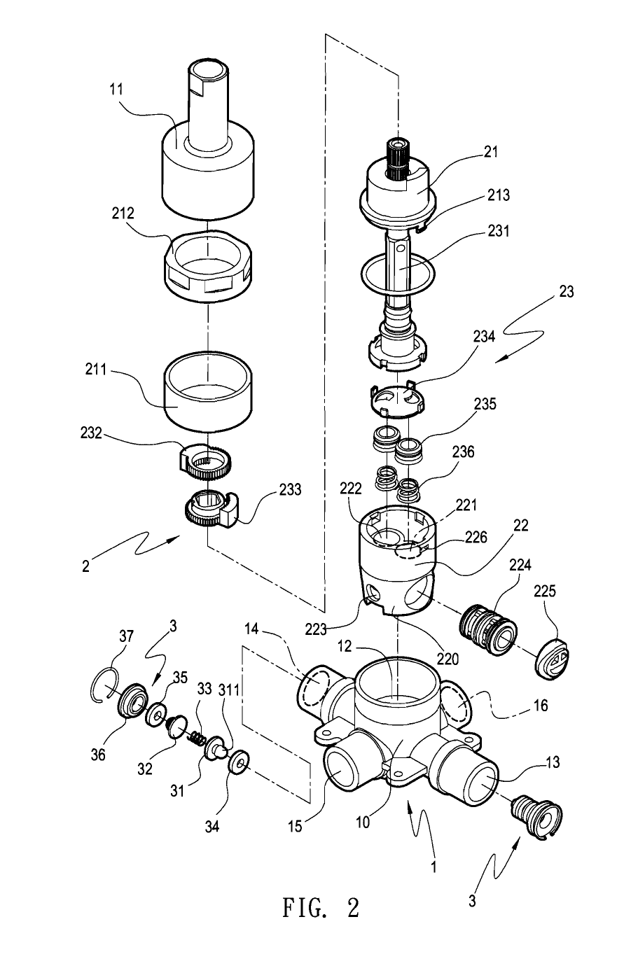

Referring to FIGS. 1 and 2, FIG. 1 is an outside view of the present invention, and FIG. 2 is an exploded perspective view of the present invention.

The faucet of the present invention includes a valve seat 1, a control valve set 2, and two pressure balance valve sets 3.

The valve seat 1 includes a seat body 10 and a cover 11, and once the seat body 10 and the cover 11 are combined together, the control valve set 2 may be disposed therein. The seat body 10 has a valve chamber 12 therein, and has two water entries 13, 14 and two water exits 15, 16 communicating with the exterior from the valve chamber 12. The water entries 13, 14 each have one of the pressure balance valve sets 3 disposed therein.

The control valve set 2 includes an upper casing 21, a lower casing 22, and a control component 23 disposed there-between.

A ring 211 and a screw cap 212 are sleeved on an outer edge of the upper casing 21.

The lower casing 22 is an integrated structure manufactured through plastic injection moulding. The diameter of the lower casing 22 is relatively small at an end far away from the upper casing 21, and it is gradually increased towards an end adjacent to the upper casing 21, so as to form a conical guide portion 220. A plurality of diversion channels 221, 222, and 223 for respectively communicating the water entries 13, 14 and the water exits 15, 16 with the control component 23 is integrally formed in the lower casing 22. A water dividing member 224 is disposed in the diversion channel 221, and is fixed through a cover plate 225. Furthermore, a plurality of catching slots 226 is disposed at the lower casing 22 adjacent to the upper casing 21, and the upper casing 21 has hooks 213 respectively corresponding to the catching slots 226, such that the upper casing 21 and the lower casing 22 may be fixed together by engaging the hooks 213 with the catching slots 226.

The control component 23 includes a revolving shaft 231, and the revolving shaft 231 penetrates the upper casing 21 and is sequentially combined with a left stopper 232 and a right stopper 233, and the revolving shaft 231 further penetrates the cover 11 of the valve seat 1 to be combined with a handle (not shown). The other end of the revolving shaft 231 extends in the lower casing 22, and is sequentially combined with a water division seat 234, two waterway sleeves 235, and two springs 236, in which each waterway sleeve 235 and each spring 236 are respectively disposed in the diversion channels 221 and 222.

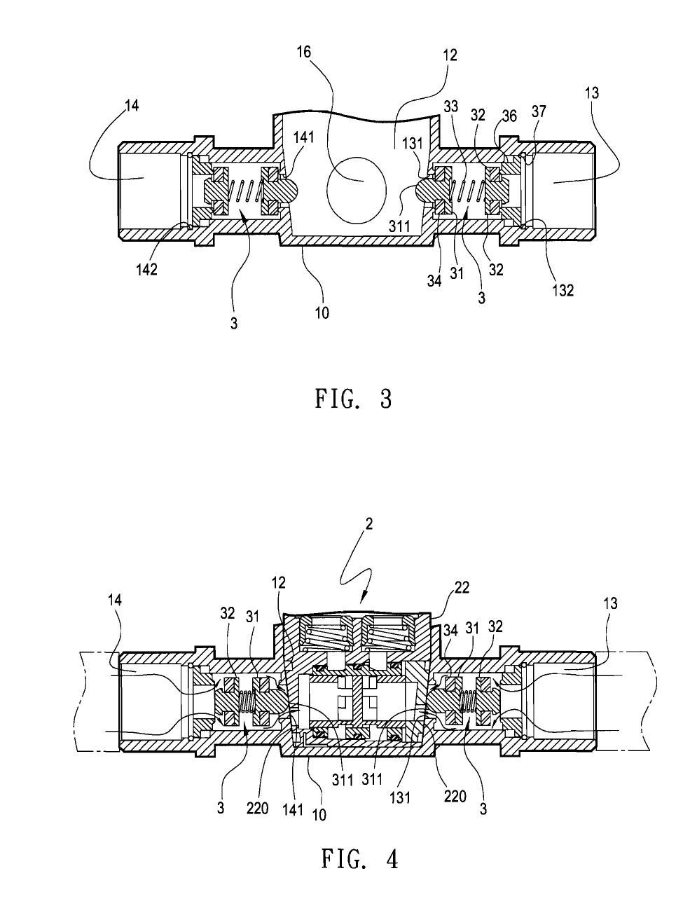

Referring to FIGS. 2 and 3, FIG. 3 is a cross-sectional view of a combination of the pressure balance valve sets 3 and the seat body 10 of the present invention. Each water entry 13, 14 of the seat body 10 has one pressure balance valve set 3 disposed therein, and each water entry 13, 14 has a water inlet 131, 141 with a smaller diameter at an end adjacent to the valve chamber 12, and each has an annular snap slot 132, 142 at a section far away from the valve chamber 12.

Each pressure balance valve set 3 has two valve sheets 31, 32, and an elastic component 33 disposed between the two valve sheets 31, 32. The valve sheets 31, 32 have water-sealing pads 34, 35 respectively sleeved on a surface opposite to the elastic component 33. A stop ring 36 and a C-shaped snap ring 37 are respectively disposed at ends of the pressure balance valve sets 3 far away from the water inlets 131, 141. By snapping the C-shaped snap ring 37 into the snap slots of the water entries, the pressure balance valve sets 3 are fixed in the water entries, and the water entries may be closed (the state shown in FIG. 3) as the elastic component 33 pushes against the valve sheets 31, 32. Furthermore, the valve sheet 31 of the pressure balance valve set 3 adjacent to the water inlet has a protrusion 311 protruding into the valve chamber 12 of the seat body 10. The diameter of the valve sheet 31 is greater than that of the water inlets 131, 141, an outer diameter of the protrusion 311 is smaller than that of the water inlets 131, 141, and the protrusion 311 extends into the valve chamber 12 through the water inlets 131, 141.

Referring to FIG. 4, it is a schematic view of a using state of the present invention. When the control valve set 2 of the present invention is assembled into the valve chamber 12, as the guide portion 220 of the lower casing 22 is of a conical structure, the guide portion 220 pushes against the protrusion 311 of the pressure balance valve set 3, such that the water-sealing pad 34 of the valve sheet 31 leaves from the water inlets 131, 141, so as to open the water inlets 131, 141. The water pressure of the water supply also pushes the valve sheet 32 away, so the water entries 13, 14 are in an opened state (the state shown in FIG. 4), and thus the water enters via the water entries 13, 14, then flows out from the water exit 15 or 16 under the control of the control valve set 2.

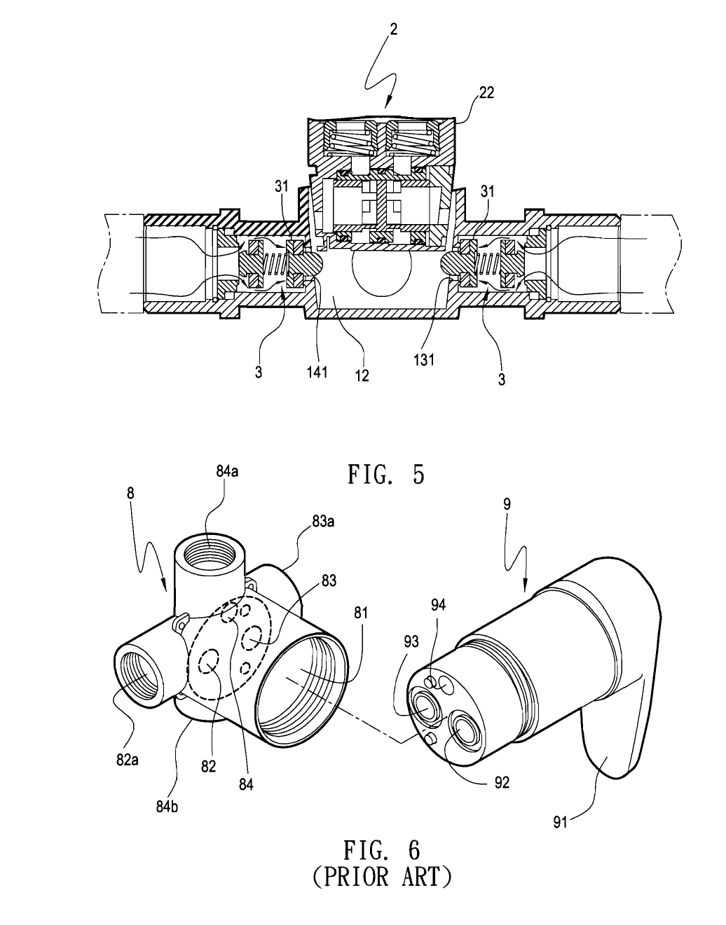

When the control valve set 2 is needed to be repaired or replaced, the maintainer can directly detach the control valve set 2. At the instant when the lower casing 22 of the control valve set 2 is removed, the valve sheet 31 of the pressure balance valve set 3 immediately closes the water inlets 131, 141 due to the elastic force of the elastic component 33 together with the water pressure, as shown in FIG. 5. In this way, when detaching the control valve set 2, the maintainer does not need to turn off the tap of the water supply before hand as in the prior art, and thus, the control valve set can be maintained or replaced conveniently.

Furthermore, the diversion channel structure with a complicated shape is designed in the lower casing 22 of the control valve set 2, so the structure in the seat body 10 becomes quite simple, as shown in FIG. 3, and thus, the seat body 10 can be easily manufactured and processed. Furthermore, the lower casing 22 with a complicate structure is also designed into an integrated structure manufactured through plastic injection moulding, and then the lower casing 22 is further combined with the components such as the water dividing member 224 and the cover plate 225, such that the lower casing 22 can also be easily manufactured. In other words, the structure of the present invention is capable of simplifying the manufacturing process, so as to reduce the cost and increase the production yield.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A faucet structure having pressure balance valves, comprising:
a valve seat, having a valve chamber therein, and having more than one water entries and at least one water exit communicating with an exterior from the valve chamber;
a control valve set, disposed on the valve seat and extending into the valve chamber, wherein the control valve set has pipes respectively corresponding to the water entries and the water exit of the valve seat; and
more than one pressure balance valve sets, disposed within the water entries, having a protrusion extending into the valve chamber, wherein the pressure balance valve sets are capable of automatically closing the water entries when without being acted by other components; the control valve set has a guide portion at an end extending into the valve chamber corresponding to the protrusion, such that when the control valve set is disposed on the valve seat, the guide portion drives the protrusion to open the pressure balance valve sets.

2. The faucet structure having pressure balance valves according to claim 1, wherein the control valve set comprises an upper casing, a lower casing, and a control component disposed there-between; and the guide portion is formed at the lower casing.

3. The faucet structure having pressure balance valves according to claim 2, wherein the lower casing is an integrated structure manufactured through a plastic injection moulding.

4. The faucet structure having pressure balance valves according to claim 3, wherein a plurality of diversion channels respectively communicating the water entries and the water exit to the control component is integrally formed within the lower casing.

5. The faucet structure having pressure balance valves according to claim 1, wherein the control valve set comprises an upper casing, a lower casing, and a control component disposed there-between; and the lower casing has a relatively small diameter at an end far away from the upper casing, such that the lower casing has a conical outer edge, so as to form the guide portion.

6. The faucet structure having pressure balance valves according to claim 5, wherein the lower casing is an integrated structure manufactured through a plastic injection moulding.

7. The faucet structure having pressure balance valves according to claim 6, wherein a plurality of diversion channels respectively communicating the water entries and the water exit to the control component is integrally formed within the lower casing.

8. The faucet structure having pressure balance valves according to claim 1, wherein the pressure balance valve set comprises at least two valve sheets and an elastic component disposed between the two valve sheets, the elastic component pushes against the two valve sheets to close the water entry, and the protrusion is formed on the valve sheet adjacent to the valve chamber.

9. The faucet structure having pressure balance valves according to claim 8, wherein a water inlet is provided at the water entry of the valve seat adjacent to the valve chamber, a diameter of the valve sheet is greater than that of the water inlet, an outer diameter of the protrusion is smaller than that of the water inlet, and the protrusion extends into the valve chamber through the water inlet.

10. The faucet structure having pressure balance valves according to claim 9, wherein the valve sheet adjacent to the water inlet further has a water-sealing pad disposed on a surface thereof.
